(19) United States
(12) Patent Application Publication
(10) Pub. No.: US 2026/0203886 A1
(43) Pub. Date: Jul. 16, 2026

(54) Polarization Imaging for Defect Detection in Irregular Reflective Surfaces

(71) Applicant: Southwest Research Institute, San Antonio, TX (US)

(72) Inventors: Edmond M. DuPont, San Antonio, TX (US); Harold A. Garza, San Antonio, TX (US)

(21) Appl. No.: 19/023,522

(22) Filed: Jan. 16, 2025

(51) Int. Cl. G06T 7/00

(52) U.S. Cl. CPC G06T 7/0004; G06T 2207/10052; G06T 2207/20084; G06T 2207/30128

(57) ABSTRACT

A system for detecting surface defects in reflective irregular surfaces, such as packaging. A polarization camera is positioned to provide images of the surface. A feature extraction process extracts features from the images, such as the Angle of Linear Polarization (AoLP), the Degree of Linear Polarization (DoLP), or the scaled depth from surface normal vectors. A neural network, trained to receive and process the feature data, provides output indicating a defect in the surface.

### BACKGROUND OF THE INVENTION

Potato chips were first sold in bulk such as out of barrels or display cases or in tins. In the 1920s, Laura Scudder, a potato chip manufacturer, asked her employees to take home sheets of wax paper and iron them into bags that could be sealed. This new packaging reduced crumbling and kept the chips fresh and crisp longer.

This innovation, along with the invention of cellophane, allowed potato chips and other types of snack chips to become a mass-market product. Today, most snack chips are packaged in plastic bags, with nitrogen gas blown in prior to sealing to lengthen shelf life and to protect the chips against crushing.

In snack chip manufacturing, the bagging process must balance speed and seal quality to maintain product freshness. Improper sealing can lead to defects like punctures and openings, resulting in stale or contaminated products.

Current detection methods for improper sealing involve compressing the bag to measure pressure loss, but this can damage the chips and increase costs by requiring larger bags for cushioning.

### BRIEF DESCRIPTION OF DRAWINGS

FIG. 1 illustrates a system for detecting surface defects in reflective packaging.

### DETAILED DESCRIPTION OF THE INVENTION

The following description is directed to a contactless inspection method, and its implementing system, for detecting surface defects in reflective packaging. The method is especially useful for detecting defects in seals of snack chip packaging and is written in terms of that type of defect. However, the method can be applied to detect defects in reflective packaging for other products and for packaging defects in addition to seals. The method could also be extended to other reflective surfaces that are irregular (not smooth and planar). The defects to be detected could be any type or hole, tear, or other anomaly in the surface that is not “normal” for that surface.

The method applies image features generated from an optical polarized imager to assess packaging integrity without compromising product quality. Polarization features of the package material highlight subtle deformations, irregular reflective properties, physical misalignments and surface deformities. The polarization features are used as inputs to a convolutional neural network (CNN) that has been trained to distinguish between defective and non-defective seals or other packaging defects.

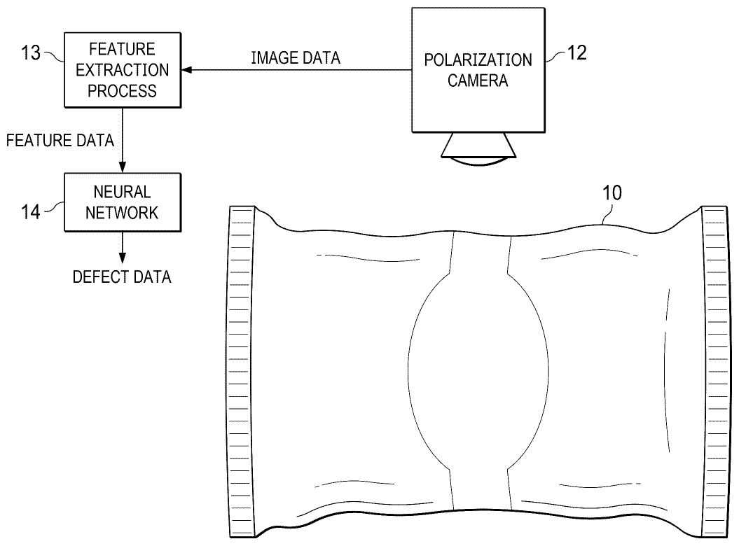

FIG. 1 illustrates a system for detecting surface defects in reflective packaging. A filled snack chip package (“chip bag”) 10 is to be inspected for defects in its seals, but as stated above, the same concepts may be applied to reflective packaging for other products and for defects in the packaging other than seals. Although only a single chip bag 10 is shown, it is expected that the inspection as applied to chip bags will occur for multiple chip bags as they proceed along a manufacturing conveying line as one of the final steps in manufacture.

A polarization camera 12 is placed to provide an overhead view of package 10. In the embodiment of this description, camera 12 is a split-pixel color polarization camera. Camera 12 combines color and polarization data at the pixel level, capturing a number of polarization orientations simultaneously. As explained below, camera 12 provides the ability to define features effective at reducing glare and enhancing contrast on reflective surfaces, such as chip bag materials. Ideally, the detection system operates in diffused lighting. The entire package surface may be imaged, processed, and evaluated, or only a portion of interest such as the seal.

For purposes of this description, “split-pixel polarization” refers to a technology where an image sensor captures different polarization states of light for individual pixels of an image. This “splits” the image data from each pixel into separate polarization components, acquired simultaneously. It is also known as “sub-pixel polarization”. Unlike traditional polarization cameras using external filters, polarization filters are integrated onto the image sensor, with each pixel divided into multiple sub-pixels, each having a different polarization filter orientation.

An example of a suitable polarization camera 12 is a Complementary Metal-Oxide-Semiconductor (CMOS) camera with different angle polarizers formed on-chip. In the example of this description, four orientations (0°, 45°, 90°, and 135°), are acquired.

A feature extraction process 13 receives the image data from camera 12 and extracts defect detection features. As the chip package is presented within the frame of camera 12, these features are extracted by process 13 in real time.

One aspect of the invention is the recognition of certain packaging features that can be extracted from the image data provided by camera 12 and used as input to a learning system, which is typically a convoluted neural network as explained below. These features may include the Angle of Linear Polarization (AoLP), the Degree of Linear Polarization (DoLP), and scaled depth from surface normal vectors. These features (AoLP, DoLP, and scaled depth) are referred to herein as “defect detection features”. They represent surface characteristics including reflectivity, texture, and structure details that enhance modeling of material properties and subtle deformations. The method is not limited to these features and can be extended to extract additional intensity features.

More specifically, the polarization data from camera 12 allows for the extraction of features that comprise the AoLP, DoLP, and scaled depth from surface normal vectors, which indicate information about surface textures and inconsistencies. Defects, such as incomplete seals, often cause irregular light scattering, which is more detectable at certain polarization angles. AoLP represents the predominant polarization angle after light reflects off a surface. This feature captures subtle surface deformations, as areas with defects altered the light reflection compared to the surrounding material. DoLP quantifies the proportion of polarized light in a scene, with higher values indicating organized light reflection. Changes in DoLP help identify material inconsistencies, such as wrinkles or incomplete seals, by flagging areas with irregular reflective properties.

Scaled depth from surface normals, derived from AoLP and DoLP data, provide a depth representation of the package seal. The scaled depth feature captures physical deformations, adding geometric contextual information of the surface geometry. Normal vectors, which encode the surface orientation at each pixel, are used to estimate the gradients of the surface. By integrating surface gradients across the image, a depth map may be reconstructed, capturing the three-dimensional geometry of the surface.

It is assumed that feature extraction process 13 has appropriate hardware and software for extracting the above-described defect detection features from the image data provided by camera 12.

A neural network 14 receives defect feature data from feature extraction process 13 and performs a defect classification process. An example of a suitable neural network is the EfficientNet CNN (convoluted neural network). The EfficientNet is a CNN that optimizes network depth, width, and resolution for transfer learning tasks, leveraging pre-trained models to initially adapt to new smaller datasets efficiently. In general, any one of various CNNs capable of automatically and adaptively learning spatial hierarchies from input features through layers of convolutional filters for defect classification may be used.

The defect detection features are processed by a trained neural network 14, which signals if the package is defective or not. The output of neural network 14 may be integrated with the snack chip manufacturing packaging process as part of the quality control system.

Neural network 14 is trained by building a database by imaging both defective and non-defective snack chip package samples. The package samples can include a variety of chip types and packaging sizes. Analysis of this database provides insights into how polarized light reflects off various surfaces of reflective package materials.

The training data comprises defect detection features as input features to neural network 14. For purposes of example herein, the training may be for the above-described defect detection features from package seals.

In image processing terms, a defective package is “modeled” in terms of the above-described defect detection features. During training, the model's performance is continuously evaluated using key metrics, including accuracy, precision, and recall, to ensure robustness.

In sum, pixel-level polarization imaging generates features that can be applied detecting defects on reflective package materials. These features contribute to identifying defects more reliably than standard color imaging could achieve with only intensity. The combined features model the geometric structure of the package for improved detection. Unlike conventional color imaging that requires multiple cameras or different views, polarization data leverages surface reflections to generate a scaled depth representation of the object's shape, which is a major advantage to using this system for spatial analysis to identify variations in surface geometry of packaging.

1. A system for detecting surface defects in an irregular reflective surface comprising:
a polarization camera, arranged to provide images of the surface, the images representing multiple polarization angles from the surface;
a feature extraction process programmed to extract features from the images, the features being one or more of the following: Angle of Linear Polarization (AoLP), Degree of Linear Polarization (DoLP), or scaled depth from surface normal vectors; thereby providing defect feature data; and
a neural network trained to receive defect feature data, to process the defect feature data, and to provide output indicating a defect in the surface.

2. The system of claim 1, wherein the polarization camera is a split-pixel polarization camera.

3. The system of claim 1, wherein the neural network is a convolutional neural network.

4. The system of claim 1, wherein the surface is a surface of packaging.
